(19) United States
(12) Patent Application Publication
(10) Pub. No.: US 2008/0129472 A1
(43) Pub. Date: Jun. 5, 2008

(54) PANIC ALARM SYSTEM AND METHOD FOR MOTOR VEHICLES

(76) Inventor: David McScott O'Kere, McDonough, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/776,880

(22) Filed: Jul. 12, 2007

Related U.S. Application Data
(60) Provisional application No. 60/861,807, filed on Nov. 30, 2006.
(60) Provisional application No. 60/873,774, filed on Dec. 7, 2006.

(51) Int. Cl. B60Q 1/00

(52) U.S. Cl. 340/426.1

(57) ABSTRACT

A method for communicating a message on an exterior of a motor vehicle, the method comprising the steps of receiving a signal from a first communication device, communicating a message to a second communication device, the second communication device comprising a display device that is visible from the exterior of the motor vehicle, and displaying the message on the second communication device.

### CROSS-REFERENCE TO RELATED APPLICATION

This application claims priority to and the benefit of copending U.S. provisional patent application entitled “PANIC ALARM SYSTEM AND METHOD FOR MOTOR VEHICLES” filed on Nov. 30, 2006 and accorded Ser. No. 60/861,807, which is entirely incorporated herein by reference. This application claims priority to and the benefit of copending U.S. provisional patent application entitled “PANIC ALARM SYSTEM AND METHOD FOR MOTOR VEHICLES” filed on Dec. 7, 2006 and accorded Ser. No. 60/873,774, which is entirely incorporated herein by reference.

### BACKGROUND

Motor vehicles are frequently the target of theft because of their high value and utility. Such thefts occur in many fashions, the most dangerous of which is carjackings. A carjacking occurs when a thief approaches the owner of an automobile and threatens them if they do not turn over their vehicle. Carjackers frequently abduct the vehicle owner and occupants along with the vehicle. In many of these incidents, the vehicle owner and occupant are injured, and even sometimes killed.

Automobile security devices have been offered but have not generally had a significant impact on theft, especially on carjackings. Traditional security devices such as car alarms operate by securing the vehicle against physical break-ins but this does not help the owner of a vehicle who has a gun pointed at them. In such a scenario, traditional security systems simply do not offer any protection.

### SUMMARY

Embodiments of the present invention provide a system and method for a panic alarm system for motor vehicles.

Briefly described, in architecture, one embodiment of the system, among others, can be implemented as follows: a system comprising a power supply, an activation switch coupled to the power supply, and a display device coupled to the activation switch. The display device configured to display a message that is visible from an exterior of a motor vehicle.

Briefly described, one embodiment of the system, among others, can be implemented as follows: a system comprising means for receiving a signal from a first communication device, means for communicating a message to a second communication device that comprises a display device visible from an exterior of a motor vehicle, and means for displaying the message on the second communication device.

The present invention can also be viewed as providing methods for communicating a message on an exterior of a motor vehicle. In this regard, one embodiment of such a method, among others, can be broadly summarized by the following steps: receiving a signal from a first communication device, communicating a message to a second communication device that comprises a display device visible from the exterior of the motor vehicle, and displaying the message on the second communication device.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1a is a block diagram of an example embodiment of a motor vehicle panic alarm system.

FIG. 1b is a block diagram of an alternate example embodiment of a motor vehicle panic alarm system.

FIG. 2 is a hardware block diagram of a computer that can be used to implement one or more of the components disclosed herein such as the controller of FIG. 1a and FIG. 1b.

FIG. 3a is a flow chart representing the operation of FIG. 1a.

FIG. 3b is a flow chart representing the operation of FIG. 1a.

FIG. 3c is a flow chart representing the operation of FIG. 1b.

FIG. 4a is a perspective view of an example embodiment of the display device(s) of FIGS. 1a and 1b.

FIG. 4b is a perspective view of an example embodiment of the display device(s) of FIGS. 1a and 1b.

FIG. 4c is a top view of an example embodiment of the display device(s) of FIGS. 1a and 1b.

### DETAILED DESCRIPTION

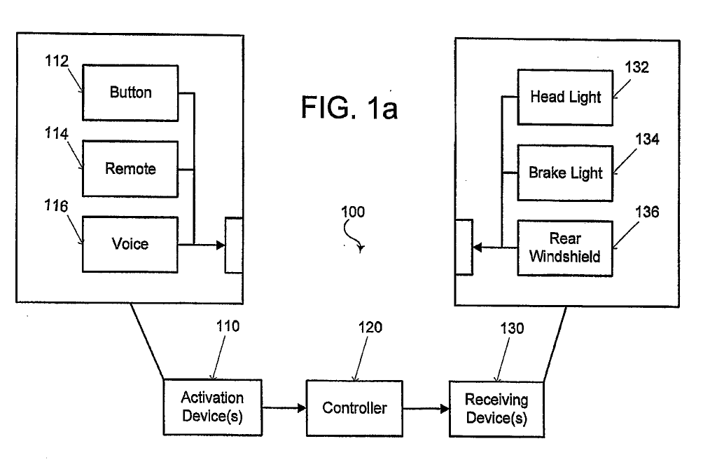

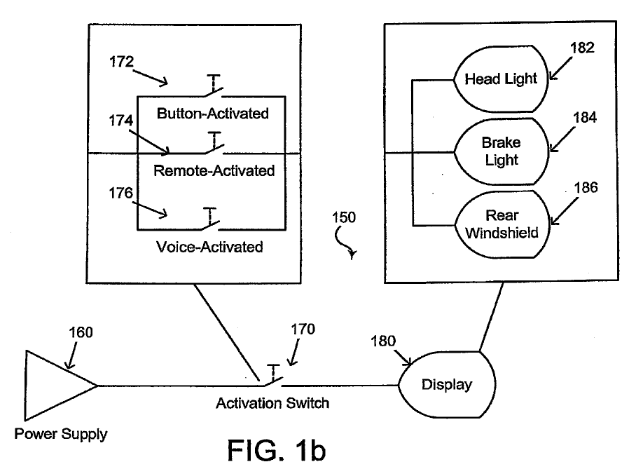

FIG. 1a shows a block diagram representing a motor vehicle panic alarm system 100. The system 100 comprises one or more activation devices 110 connected to a controller 120 which is further connected to a display device 130.

The activation devices 110 of the example embodiment can be implemented in several fashions. One example embodiment of an activation device 110 is a button 112 located on the interior of the motor vehicle. The button 112 is configured send a signal, upon activation, to the controller 120. The button 112 may be located in several places, including, but not limited to, the interior of the doors, on the bottom of the seats within the motor vehicle, on the dashboard, on the sun visor, and on the interior wall of the trunk of the motor vehicle. Examples of buttons 112 are discussed in “PUSH-BUTTON SWITCH WITH OVERLOAD PROTECTION FUNCTION AND CIRCULAR TYPE ACTUATION MECHANISM,” U.S. Pat. No. 6,545,851, “PUSH BUTTON SWITCH FOR VEHICLE,” U.S. Pat. No. 7,064,287, which are entirely incorporated herein by reference.

The activation device 110 can also be implemented as a remote control device 114. The remote control device 114 is configured to send a signal, upon activation, to the controller 120. The remote control device 114 can be implemented in many ways, including, for example, but not limited to, using an RF transmitter, an infrared transmitter, a wireless transmitter, etc. A non-limiting example of the remote control device 114 is a releasably secured RF device attached to a key chain or a belt clip. Examples of programmable remote controls that can be implemented as the remote control device 114 are discussed in “METHOD AND APPARATUS FOR REMOTE CONTROL,” U.S. Pat. No. 7,227,444, and “PROGRAMMING A UNIVERSAL REMOTE CONTROL,” U.S. Pat. No. 7,106,209, which are entirely incorporated herein by reference.

The activation device can also be implemented as a voice activated sensor 116. The voice activated device 116 is configured to recognize any of a number of pre-determined phrases and, in response, send a signal to the controller 120. The voice activated device 116 can be implemented in many ways, as will be appreciated by one skilled in the art. The voice activated device 116 can be implemented as a microphone located on the interior of the motor vehicle. The microphone captures audio signals and is configured to recognize predetermined phrases and operate in the event one of these predetermined phrases is spoken. An example of such a predetermined phrase is “Please God, don't shoot me.” This phrase is a non-limiting example of a phrase which can be set by the manufacturer or by the customer. Examples of voice recognition devices which could be used to implement the voice activation device 116 are discussed in “VOICE RECOGNITION APPARATUS FOR VEHICLE,” U.S. Pat. No. 7,212,966, and “SYSTEM AND METHOD FOR TELEPHONIC SWITCHING AND SIGNALING BASED ON VOICE RECOGNITION,” U.S. Pat. No. 6,999,564, which are entirely incorporated herein by reference.

The controller 120 can be implemented in hardware, software, firmware, or a combination thereof. In the preferred embodiment(s), the controller is implemented in software or firmware that is stored in a memory and that is executed by a suitable instruction execution system. If implemented in hardware, as in an alternative embodiment, the controller can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. The controller 120 is configured to receive a signal from the activation device 110 and transmit a signal to the receiving device 130. The transmitted signal can be in the form of an emergency message, such as “Carjacked, Kidnapped, Please Call 911” or may include information concerning the incident such as the location of the motor vehicle if equipped with a Global Positioning System (GPS) device or the registration information of the motor vehicle, for example. Other information could be included in the signal, as will be appreciated by one skilled in the art.

The controller 120 can be an independent device or can alternatively be integrated with, or implemented in, an existing microprocessor in the motor vehicle. A non-limiting example of such a microprocessor is an Engine Control Unit (ECU), Airbag Module, Instrument Panel microprocessor, Transmission Control Module, or Climate Control Module.

The receiving device 130 is configured to receive a signal from the controller 120. The receiving device 130 can be implemented in several fashions. One example embodiment is a display device visible on the exterior of the motor vehicle. The display device can be located in several places, including, but not limited to, the head lights 132, the brake lights 134, the rear windshield 136, and the side windows. The receiving device 130 can be implemented in any one, or more than one, of these locations and configured to display the message received from the controller 120. The display device is configured to display a message. The message may be configured to anything including, for example, “Carjacked, Kidnapped, Please Call 911”. The message is shown on a display such as an LED display located within any of the devices listed above. Examples of display devices are discussed in “EASY-TO-ASSEMBLY LED DISPLAY FOR ANY GRAPHICS AND TEXT,” U.S. Pat. No. 6,448,900, and “ELECTRONIC DISPLAY SIGN,” U.S. Pat. No. 5,796,376, which are entirely incorporated herein by reference. This is merely a non-limiting example embodiment and not meant to exclude other embodiments of a display visible from the exterior of the vehicle.

The receiving device 130 can also be implemented as a receiver configured to receive a signal from the controller 120. The receiving device 130 may be located at any number of locations including, but not limited to, a police station, a security company, or a private residence. The contents of the signal received by the receiving device 130 may vary. In one example embodiment, the receiving device 130 is configured to receive an audio message from the controller 120 and broadcast this audio message.

In an alternate example embodiment, the receiving device 130 is configured to receive a signal containing location information from the controller 120 and the receiving device 130 communicates this information to authorities. In another alternate example embodiment, the receiving device 130 is configured to receive a signal from the controller 120 containing vehicle registration information.

Many variations and modifications may be made to the above-described embodiments of the receiving device 130 without departing substantially from the spirit and principles of the invention. All such modifications and variations are intended to be included herein within the scope of this disclosure and the present invention and protected by the following claims.

FIG. 1b shows an alternate example embodiment of a motor vehicle security system 150. A power supply 160 is connected to an activated switch 170 which is connected to a display device 180. The power supply 160 can be implemented in several fashions as will be appreciated by one skilled in the art. The power supply 160 can be implemented as, for example, but not limited to, an automobile battery, an alternating current power converter connected to the automobile battery, an independent battery, etc.

The activated switch 170 can be implemented in many ways, similar to the activation device 110 described in reference to FIG. 1a. For example, the activated switch 170 can be implemented as a button activated switch 176, a remote activated switch 174, a voice activated switch 176, or any combination of these and any other embodiments.

The display device 180 can be implemented in many ways, similar to the receiving device 130 described in reference to FIG. 1a. For example, the display device 180 can be implemented as a head light 182, a brake light 184, a rear windshield 186, or on other locations on the exterior of the vehicle. An example embodiment includes one or more of the display device(s) 180 present on a motor vehicle and activated simultaneously, sequentially, or in another way.

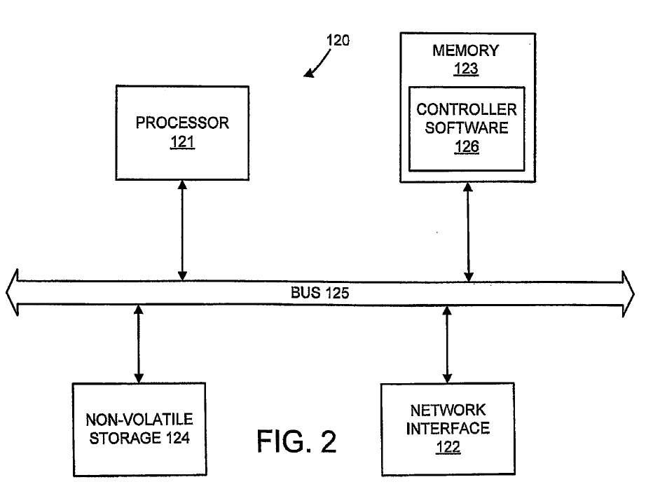

FIG. 2 is a hardware block diagram of a general-purpose computer that can be used to implement one or more of the components disclosed herein, such as the controller 120. In this example embodiment, controller 120 contains a number of components that are known in the art, including a processor 121, a network interface 122, memory 123, and non-volatile storage 124. Examples of non-volatile storage include, for example, a hard disk, flash RAM, flash ROM, EEPROM, etc. These components are coupled via a bus 125. Memory 123 contains instructions which, when executed by processor 121, implement the methods and systems disclosed herein. Omitted from FIG. 2 are a number of conventional components, known to those of ordinary skill in the art, that are unnecessary to explain the operation of the controller 120.

The controller 120 disclosed herein can be implemented in software, hardware, or a combination thereof. In some embodiments, the system and/or method is implemented in controller software 126 that is stored in a memory 123 and that is executed by a suitable processor 121 situated in a computing device. However, the systems and methods can be embodied in any computer-readable medium for use by or in connection with an instruction execution system, apparatus, or device. Such instruction execution systems include any computer-based system, processor-containing system, or other system that can fetch and execute the instructions from the instruction execution system. In other embodiments, the controller 120 is implemented in hardware, including, but not limited to, a programmable logic device (PLD), programmable gate array (PGA), field programmable gate array (FPGA) or an application-specific integrated circuit (ASIC).

In the context of this disclosure, a “computer-readable medium” can be any means that can contain, store, communicate, propagate, or transport the program for use by, or in connection with, the instruction execution system. The computer readable medium can be, for example but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) optical fiber and compact disc read-only memory (CD-ROM).

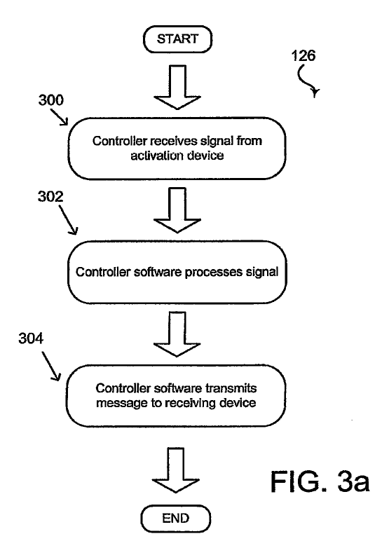

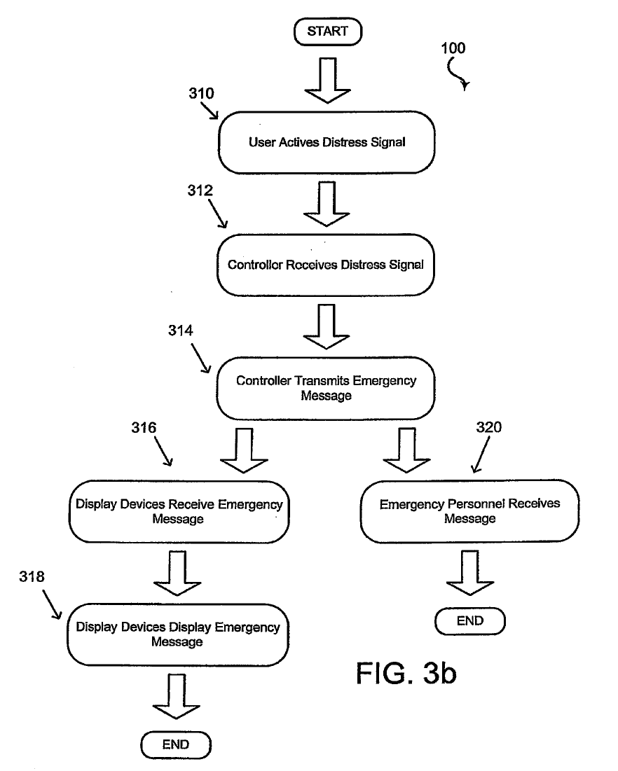

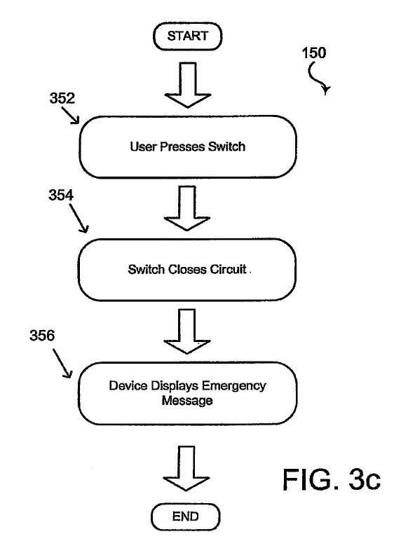

FIG. 3a shows a flowchart of a process representing the operation of an example embodiment of the controller software 126 of FIG. 2. Operation begins at block 300 where the controller 120 receives a signal from an activation device 110. Next, at block 302, the controller software 126 processes the received signal. At block 304, the controller software 126 transmits a message to the receiving device 130.

FIG. 3b shows a flowchart of a process representing the operation of an example embodiment of the motor vehicle panic alarm system 100 of FIG. 1a. Operation begins at block 310 when the user activates a distress signal by engaging any of the activation devices 110. Embodiments include, but are not limited to, a button activated device 112, remote activated device 114, or a voice-activated device 116.

The controller 120 receives the distress signal from the activation device 110 at block 312. The controller 120 then transmits an emergency message to receiving device(s) 130 at block 314. Example embodiments of recording device 130 are explained above and include a display device. The display device receives the emergency message at block 316. At block 318, the display device displays the received emergency message as described above and operation is complete.

If the receiving device 130 is implemented in another fashion, for example as a receiver monitored by emergency personnel, then at block 320 the receiver receives the emergency message from controller 120 and responds accordingly. Such a response might include notifying authorities of the message, which may include the location of the motor vehicle if equipped with a Global Positioning System (GPS) device.

FIG. 3c shows a flowchart of a process representing the operation of an example embodiment of the motor vehicle panic alarm system 150 of FIG. 1b. Operation begins when an activation switch 170 is engaged. The activation switch 170 can be implemented in several fashions, as described above, and engaging any activation switch 170 will initiate at block 352. Block 354 occurs next, where the activation switch 170 closes the circuit between the power supply 160 and the display device 180. Closing this circuit results in power being provided to the display device 180, which, at block 356, displays a pre-configured emergency message.

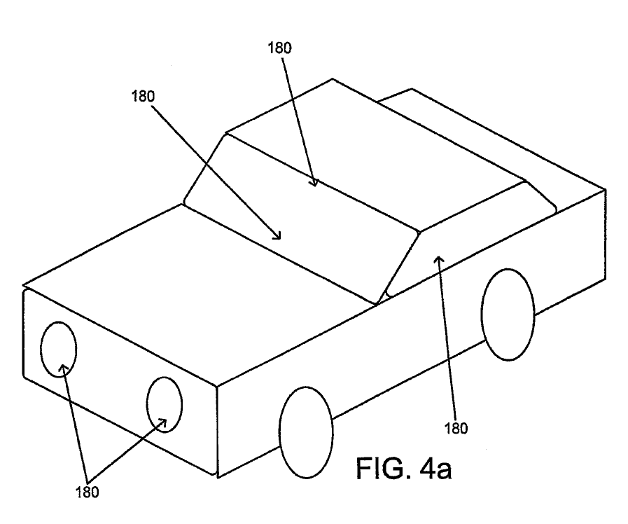

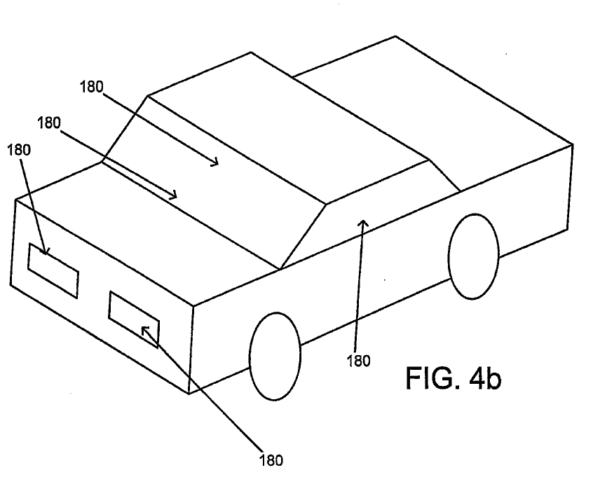

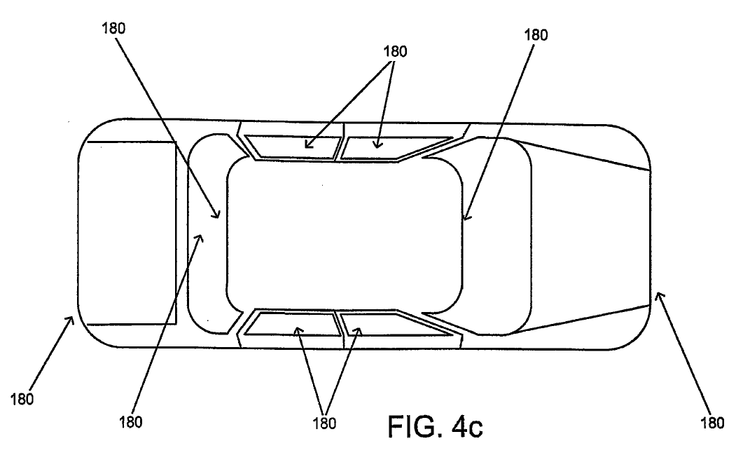

FIG. 4a is a front view of an example embodiment of the motor vehicle, shown here as a car. Example embodiments of display device 180 are shown in several possible locations including the headlights, the bottom of the front windshield on the top of the dashboard, and the top of the front windshield on the back of the rearview mirror.

FIG. 4b is a rear view of an example embodiment of the motor vehicle, shown here as a car. Example embodiments of display device 180 are shown in several possible locations including the brake lights, the bottom of the rear windshield on the top of the rear seats, the top of the rear windshield the windshield brake light, and on the side window.

FIG. 4c is a top view of an example embodiment of the motor vehicle, shown here as a car. Example embodiments of display device 180 are in several possible locations including the brake lights, the bottom of the rear windshield on the top of the rear seats, the top of the rear windshield the windshield brake light, and on the side window. Also shown are display devices 400 located on the headlights and the top of the front windshield on the back of the rearview mirror.

Any process descriptions or blocks in flow charts should be understood as representing modules, segments, or portions of code which include one or more executable instructions for implementing specific logical functions or steps in the process, and alternate embodiments are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention are merely example embodiments, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method for communicating a message on an exterior of a motor vehicle, the method comprising the steps of:
receiving a signal from a first communication device;
communicating a message to a second communication device, the second communication device comprising a display device that is visible from the exterior of the motor vehicle; and
displaying the message on the second communication device.

2. The method of claim 1, wherein the receiving step comprises receiving signals from a plurality of first communication devices.

3. The method of claim 2, wherein the plurality of first communication devices includes at least one of the following: a wireless communication device, a button activated communication device located inside the motor vehicle, a button activated communication device located inside a trunk of the motor vehicle, and a voice-recognition device configured to recognize at least one phrase

4. The method of claim 3, wherein the at least one phrase comprises at least one programmable phrase.

5. The method of claim 1, wherein the communicating step comprises communicating the message to a plurality of second communication devices.

6. The method of claim 5, wherein the plurality of second communication devices includes at least one of the following: a brake light of the motor vehicle, a head light of the motor vehicle, a display on the rear windshield of the motor vehicle, a display on a side window of the motor vehicle, and a sign on top of the motor vehicle.

7. The method of claim 5, wherein the message comprises a static message.

8. The method of claim 1, wherein the message comprises a programmable message.

9. The method of claim 1, wherein the second communication device comprises an emergency response device.

10. The method of claim 9, wherein the message comprises a location of the motor vehicle.

11. A system comprising:
a power supply;
an activation switch coupled to the power supply; and
a display device coupled to the activation switch, the display device configured to display a message that is visible from an exterior of a motor vehicle.

12. The system of claim 11, wherein the activation switch comprises one of the following: a button activated switch, a remotely activated switch, and a voice activated switch.

13. The system of claim 11, further comprising one or more additional activation switches.

14. The system of claim 11, wherein the display device comprises an LED display positioned on or about the rear windshield of the motor vehicle.

15. A system comprising:
means for receiving a signal from a first communication device;
means for communicating a message to a second communication device, the second communication device comprising a display device that is visible from an exterior of a motor vehicle
means for displaying the message on the second communication device.

16. The system of claim 15, wherein the first communication device comprises a plurality of first communication devices including at least one of the following: a wireless communication device, a button activated communication device located inside the motor vehicle, a button activated communication device located inside a trunk of the motor vehicle, and a voice-recognition device configured to recognize at least one phrase.

17. The system of claim 15, wherein the second communication device comprises a plurality of second communication devices including at least one of the following: a brake light of the motor vehicle, a head light of the motor vehicle, a display on the rear windshield of the motor vehicle, a display on a side window of the motor vehicle, and a sign on top of the motor vehicle.
